(19) United States
(12) Patent Application Publication
(10) Pub. No.: US 2017/0189882 A1
(43) Pub. Date: Jul. 6, 2017

(54) PRECONCENTRATOR FOR ABSORBING/DESORBING AT LEAST ONE COMPONENT OF GAS

(71) Applicant: SIEMENS AKTIENGESELLSCHAFT, München (DE)

(72) Inventors: Ignaz EISELE, Icking (DE); Maximilian FLEISCHER, Höhenkirchen (DE); Harry HEDLER, Germering (DE); Markus SCHIEBER, München (DE); Jörg ZAPF, München (DE)

(21) Appl. No.: 15/325,178

(22) PCT Filed: Jun. 15, 2015
(86) PCT No.: PCT/EP2015/063293

§ 371 Date: Jan. 10, 2017

(30) Foreign Application Priority Data
Jul. 16, 2014 (DE) 10 2014 213 874.4

(51) Int. Cl. B01J 15/00; B01J 20/28

(52) U.S. Cl. CPC B01J 15/00; B01J 20/28033; B01J 20/28095

(57) ABSTRACT

The disclosure pertains to a microstructure for adsorbing/desorbing at least one gas component of a gas supplied to the microstructure. The microstructure includes a semiconductor substrate having a bottom and a top. The microstructure also includes a plurality of micro-channels, extending from the bottom to the top of the semiconductor substrate. A top surface of micro-channel is configured to adsorb and/or desorb the at least one gas component when the gas is passed through the micro-channels.

The present patent document is a §371 nationalization of PCT Application Serial Number PCT/EP2015/063293, filed Jun. 15, 2015, designating the United States, which is hereby incorporated by reference, and this patent document also claims the benefit of DE 10 2014 213 874.4, filed Jul. 16, 2014, which is also hereby incorporated by reference.

### TECHNICAL FIELD

The disclosure relates to a microstructure for adsorbing and/or desorbing at least one gas component of a gas supplied to the microstructure, having a semiconductor substrate with an underside and a top side. The disclosure also relates to a method for producing a microstructure, to an apparatus for detecting at least one gas component with a microstructure, and to a method for operating an apparatus.

### BACKGROUND

Direct identification of volatile organic compounds (VOCs) in complex mixtures is important for human impacts on the environment, in the detection of diseases, in determining air quality, in biomedical diagnosis, and in many other contexts, such as those relevant to health. The complex mixtures may be gases in which the volatile organic compounds are gas components. The gas components may be toxic gases in ambient air or evaporated quantities of an explosive to be measured in the context of explosive detection. An important measure for the variables to be analyzed, (e.g., the gas components to be analyzed), is their concentration. However, for many of the substances that are to be analyzed, the concentration is close to or below the resolution limit of current detector systems.

In order to detect the concentration of gas components, (e.g., low concentrations of the gas components in the gases), there are known from the prior art devices designed to adsorb and/or desorb the gas components. These devices, which in the following are termed preconcentrators, may be used to enrich components of gases (for example, on a surface of the device), these components being released again after a predetermined time in order to be supplied to a measurement device.

Preconcentrators known from the prior art include macroscopic and microscopic structures. Macroscopic structures may include gas collecting tubes filled with gas-collecting plastic granules or activated charcoal. A certain quantity of air is for example pumped through these tubes while the collector is cold. In that context, the temperature of the collector is at most ambient temperature. After this, the gas collecting tube is rapidly heated and flushed with a small flow of gas, and as a result the rapidly desorbing gas may be supplied with a greater concentration to a measuring device, (for example, a sensor or a gas chromatograph). Macroscopic structures have the drawback that they may require a large amount of space and therefore the options for using macroscopic preconcentrators are restricted.

Micromechanical structures include an etched channel or a plate structure that may, for example, have a rough surface. The etched channel or the plate structure may be coated with an adsorption material. The microscopic structures according to the prior art have the drawback that the surface of the micromechanical structures and thus their collecting capacity are small. In order to increase the collecting capacity of the microscopic structures, a certain length, in the gas flow direction, of the etched channel or of the plate structure is maintained. This results in the drawback that, during the desorption process, retention or gas separation effects arise as in the context of a gas chromatograph, and as a result the gas may not be used in its entirety for an abrupt concentration change in the form of a flow injection.

Another micromechanical structure is described in Microchemical Journal 98 (2011) 240-245 “Characterization of poly(2,6-diphenyl-p-phenylene oxide) films as adsorbent for microfabricated preconcentrators” (Bassam Alfeeli, Vaibhav Jain, Richard K. Johnson, Frederick L. Beyer, James R. Heflin, Masoud Agah). This paper describes what are referred to as micro-preconcentrators that have a large number of three-dimensional micro-columns. Although these micro-columns have a large surface area and thus a greater collecting capacity than the etched channel or the plate structure, the micro-columns may be unstable.

### SUMMARY AND DESCRIPTION

The scope of the present disclosure is defined solely by the appended claims and is not affected to any degree by the statements within this summary. The present embodiments may obviate one or more of the drawbacks or limitations in the related art.

The present disclosure has the object of creating a reliable, stable, and miniaturized structure by which it is possible to detect even small concentrations of gas components.

This object is achieved with a microstructure, a method for producing the microstructure, an apparatus with a microstructure, and a method for operating the apparatus.

The microstructure serves for adsorbing and/or desorbing at least one gas component of a gas supplied to the microstructure, and includes a semiconductor substrate with an underside and a top side. The microstructure also has a plurality of micro-channels, which each extend from the underside to the top side of the semiconductor substrate, and thus from the top side of the microstructure to the underside of the microstructure, wherein a surface of the respective micro-channels is designed for adsorbing and/or desorbing the at least one gas component when the gas flows through the respective micro-channels.

The microstructure may therefore be used to create a preconcentrator that may bind and/or release gas components of a gas. Such a gas component may be toxic gas molecules in ambient air or molecules of a volatile component in a person's breath. However, the preconcentrator may also be used in liquids, and in that context adsorb and/or desorb components of a liquid flowing through the micro-channels.

Silicon may be used as the semiconductor substrate. This semiconductor material may be pierced with a large number of micro-channels, also termed micro-pores. This forms a high-density array of micro-channels, with each of the micro-channels establishing a continuous connection between the top side of the semiconductor substrate and the underside of the semiconductor substrate. In that context, the micro-channels may be arranged parallel to one another in a periodic sequence. That makes it possible for a gas to flow, for example, from the top side of the semiconductor substrate through the micro-channels to the underside of the semiconductor substrate. In that context, the gas enters the microstructure through openings of the micro-channels, (for example, on the top side of the semiconductor substrate), flows through the micro-channels, and exits through openings of the micro-channels on the underside of the semiconductor substrate. As the gas flows through, at least one gas component may remain stuck to the surface of the respective micro-channels. The micro-channels make it possible to increase the surface area of the semiconductor substrate, to which the at least one gas component may be adsorbed, by up to 300 times in comparison to the basic surface area of the semiconductor substrate without the micro-channels. This greatly increased surface area makes it possible to shift the lower detection limit for the concentration of the at least one gas component, (e.g., for the number of molecules of the at least one gas component), by approximately two orders of magnitude.

The surface of the respective micro-channels may be formed by a surface structure of the respective micro-channels on the internal wall thereof. In order to increase the adsorption rate of the at least one adsorbed gas component of a supplied gas, it is possible for a surface structure to be formed on the internal wall of micro-channels, to which structure the components of the supplied gas and/or of the supplied liquid may be bound particularly well. This makes it possible to improve the adhesion properties of the surface of the micro-channels.

The surface of the respective micro-channels may be formed by a coating that is applied to an internal wall of the respective micro-channels. Coatings of this type, which are also termed adsorbents, may be porous polymers such as Tenax® TA which may collect all types of gases in the air in their approximately 0.2 micrometer-large pores. Other suitable coating materials are for example Carboxen®, silica gel, crystalline materials (MOFs) or zeolites. These materials are particularly high performance adsorbents since they have particularly good adhesion properties for gas components, for example, and may particularly advantageously bind gas components. Coating may be effected by vapor deposition of the adsorbents on the internal walls of the micro-channels.

One embodiment provides that the microstructure has a temperature control element for controlling the temperature of the semiconductor substrate. The temperature control element may be used to heat and/or cool the microstructure, in particular, the semiconductor substrate. By cooling the semiconductor substrate, (for example, by a thermoelectric Peltier cooler), it is possible to multiply the adsorption of the at least one gas component. In addition, the temperature control element may be used to heat the semiconductor substrate. By rapidly heating the preconcentrator, the molecules of the at least one gas component accumulated on the surface of the micro-channels may be abruptly released, that is to say desorbed. This produces a many-fold increase in concentration in the vicinity of the structure. A preconcentrator, which is for example made of silicon, permits desorption temperatures of up to 800° C., in particular up to 900° C. By virtue of the good thermal conductivity of silicon and by virtue of the preconcentrator being configured as a microstructure having very low mass, very rapid heating times, (for example, in the region of 10 to 100 milliseconds), for very low energy consumption, (for example, in the region of 10 to 100 milliwatts), may be made possible.

It may be provided that the temperature control element is arranged on the top side of the semiconductor substrate. To that end, a heating element may be applied in a meandering shape to the surface of the semiconductor substrate, for example, in order to heat the microstructure. The temperature control element may also take the form of a thermally conductive layer. It is thus possible for the temperature control element to be integrated in a particularly space-saving manner in the microstructure.

The temperature control element may have a plurality of through-openings that correspond to the micro-channels and are arranged in line with the respective micro-channels. Each one of the micro-channels has an opening, (for example, on the top side of the semiconductor substrate), through which the gas may enter the micro-channels, and an opening, (for example, on the underside of the semiconductor substrate), through which the gas may exit. The temperature control element, which is for example arranged on the top side of the semiconductor substrate, may in that context be configured such that it does not cover or close the openings of the micro-channels on the top side of the semiconductor substrate. To that end, the temperature control element may have a plurality of through-openings that may lie congruent with the openings of the micro-channels on the top side of the semiconductor substrate. Thus, all of the micro-channels arranged in the semiconductor substrate may be used for adsorbing and/or desorbing a gas component of a gas supplied to the microstructure.

In one advantageous configuration, the microstructure has at least one thermally conductive element extending from the top side to the underside of the semiconductor substrate. The at least one thermally conductive element may therefore be integrated in a particularly space-saving manner in the preconcentrator.

The micro-channels may be arranged in a first region of the semiconductor substrate and the at least one thermally conductive element is arranged in a second region, different from the first region, of the semiconductor substrate. The at least one thermally conductive element, which may be coupled to an external heat source, may serve to conduct heat. The at least one thermally conductive element may be arranged in an edge region of the microstructure. By virtue of the spatial separation between the at least one thermally conductive element and the micro-channels, the micro-channels may be fully used for adsorbing and/or desorbing the at least one gas component.

One embodiment provides that the at least one thermally conductive element is thermally coupled to the temperature control element. By virtue of the fact that the at least one thermally conductive element extends from the top side to the underside of the semiconductor substrate, and in so doing is thermally coupled to the temperature control element, the temperature of the microstructure is particularly easy to control. It is thus possible, for example, to attach to the underside of the microstructure a device supplying the temperature control element, via the at least one thermally conductive element, with energy for heating and/or for cooling the semiconductor substrate.

Each one of the micro-channels may have a length of greater than 100 micrometers and/or a diameter of less than 20 micrometers. The great length of the micro-channels makes it possible to create a particularly large surface area of the micro-channels and therefore a particularly large collecting capacity of the micro-channels. The small micro-channel diameter makes it possible to arrange a great many micro-channels in the semiconductor substrate.

The disclosure also relates to a method for producing a microstructure. The method includes providing the semiconductor substrate, and introducing the plurality of micro-channels into the semiconductor substrate by an electrochemical etching method. A silicon wafer, structured by the etching method, may be used as the semiconductor substrate. To that end, use may be made of the Photo Assisted Electrochemical Etching (PAECE) electrochemical etching method (see Electrochemistry of Silicon: Instrumentation, Science, Materials and Applications. Volker Lehmann. Copyright © 2002 Wiley-VCH Verlag GmbH. ISBNs: 3-527-29321-3 (Hardcover); 3-527-60027-2 (Electronic)). Technology of this kind makes it possible to produce very stable, porous (that is to say, provided with micro-channels) silicon wafers that furthermore permit very small wall thicknesses of the micro-channels, of as little as 1 micrometer. In that context, the micro-channels, which pass through the entire wafer with an ordered geometry, (for example, arranged periodically and parallel), have a particularly small diameter. The structure created using PAECE has an extremely large surface area, such that under certain circumstances it is even possible to dispense with the use of an adsorbent, that is to say an adsorption material. It is however also possible for the surface of the micro-channels to be coated with an adsorption material. Moreover, the highly parallel mode of action, (e.g., throughflow of the gas through a large number of parallel micro-channels), makes it possible to avoid long gas paths.

The disclosure also encompasses an apparatus for detecting at least one gas component, the apparatus having a microstructure and a gas sensor that has a sensor surface for measuring a concentration of the at least one gas component, wherein the microstructure and the gas sensor are arranged relative to one another such that the sensor surface of the gas sensor is oriented toward the underside of the microstructure. Thus, the preconcentrator is mounted as close as possible to the sensor surface, that is to say to the active layer of the gas sensor. The gas sensor may be designed as what is termed a gas-FET. The apparatus may thus be made particularly space-saving and compact.

It may be provided that the apparatus has a micro-pump arranged relative to the microstructure such that the micro-pump is oriented toward the top side of the microstructure so as to establish a flow of the gas through the micro-channels from the top side to the underside of the microstructure. In other words, this means that the gas sensor, the preconcentrator and the micro-pump are arranged one above the other in the vertical direction. By the micro-pump, the gas with the at least one gas component is supplied to the microstructure via the micro-channels. When the gas flows through the micro-channels, the at least one gas component is adsorbed on the surface of the internal walls of the micro-channels. The preconcentrator thus “collects” the molecules of the at least one gas component. The number of molecules of the gas component adsorbed on the surface of the micro-channels, that is to say the concentration of the gas components, may be measured using the gas sensor after desorption of the molecules.

The apparatus may have a device for providing thermal energy arranged relative to the microstructure such that the device is thermally coupled to the thermally conductive element. The temperature control element of the microstructure may be temperature-controlled, that is to say heated and/or cooled, by the device. By virtue of the thermally conductive element, the device for providing thermal energy may be arranged within the apparatus in a particularly space-saving manner. The molecules of a gas component, which have collected on the surface of the micro-channels while flowing through the latter, may be desorbed by the temperature control element being supplied, by the device for providing thermal energy, for example, with heat energy. The gas sensor, in particular the sensor surface thereof, is in that context oriented toward the underside of the microstructure and is thus located in the immediate vicinity of the preconcentrator. Pulsed heating of the preconcentrator may cause the molecules of the at least one gas component to separate abruptly and for example land on the sensor surface. In that context, the gas sensor may measure the concentration of the at least one gas component on the sensor surface. Thus, using the preconcentrator it is possible to detect concentrations that, without the preconcentrator, would be below the detection limit and therefore undetectable.

The disclosure also relates to a method for operating an apparatus. The method involves introducing a gas into the micro-channels of the microstructure for adsorption of at least one gas component contained in the gas on a surface of the micro-channels, and heating the microstructure for desorption of the at least one gas component and for supplying the at least one desorbed gas component to a gas sensor for measuring the concentration of the at least one gas component in the supplied gas.

The embodiments, presented in relation to the microstructure, and the advantages thereof apply accordingly to the method for producing the microstructure, to the apparatus having the microstructure and to the method, and to the method for operating the apparatus.

### BRIEF DESCRIPTION OF THE DRAWINGS

FIG. 1 depicts a schematic illustration of an embodiment of the apparatus having a microstructure, a gas sensor, and a temperature control element.

FIG. 2 depicts a perspective view of the embodiment of the apparatus from FIG. 1.

FIG. 3 depicts a schematic illustration of another embodiment of the apparatus having a microstructure, a gas sensor, and a temperature control element.

FIG. 4 depicts a schematic illustration of the operation of another embodiment of the apparatus having a structure, a gas sensor, a temperature control element, and a micro-pump.

### DETAILED DESCRIPTION

In the context of the exemplary embodiment described herein, the components of the embodiment in each case represent individual features of the disclosure that are to be considered independently of one another and which in each case also refine the disclosure independently of one another, and are therefore to be considered individually or in a combination other than that shown, as a constituent part of the disclosure. Furthermore, the described embodiment may also be complemented by others of the already described features of the disclosure.

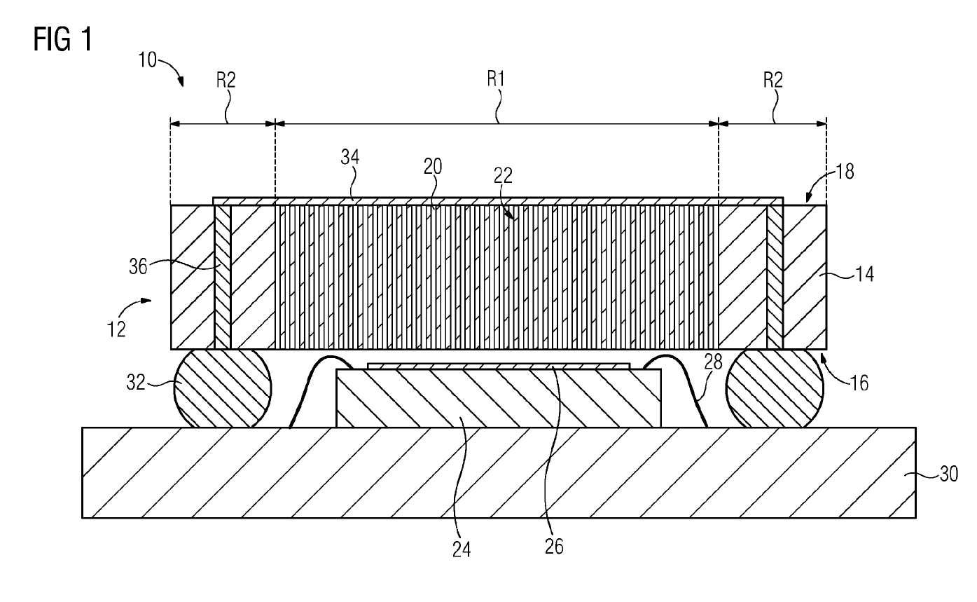

FIG. 1 depicts an apparatus 10 for detecting at least one gas component of a gas. The apparatus 10 includes a microstructure 12 and a gas sensor 24. The microstructure 12 serves as a so-called preconcentrator for adsorbing and/or desorbing the at least one gas component. The gas sensor 24 serves for measuring a concentration of the at least one gas component.

The microstructure 12 is made of a semiconductor substrate 14, for example, silicon. The microstructure 12 has an underside 16 and a top side 18. In addition, the microstructure 12 has, in a first region R1, a multiplicity, (e.g., an array), of parallel micro-channels 20, which are in particular arranged periodically. The micro-channels 20 extend from the underside 16 to the top side 18 of the microstructure 12. In that context, a gas may enter openings of the micro-channels 20 on the top side 18 of the microstructure 12, flow through the micro-channels 20 and exit at the underside 16 of the microstructure 12 via openings in the microstructure. The micro-channels 20 have a surface 22 onto which the at least one gas component of the through-flowing gas may be adsorbed. In that context, the surface 22 may be formed by the internal walls of the micro-channels 20 themselves, by a surface structure of the internal walls or by a coating of the internal walls. The coating may have an adsorption material and thus improve the adhesion properties of the surface 22 for the at least one gas component of the through-flowing gas.

In this case, the microstructure 12 is arranged above the gas sensor 24 in the vertical direction. The gas sensor 24, which has a sensor surface 26 and an electrical contact 28, is then attached to a support element 30. The microstructure 12 is arranged above the gas sensor 24 in the vertical direction such that the sensor surface 26 is oriented toward the underside 16 of the microstructure 12. The microstructure 12 is connected to the support element 30 by a connection element 32.

In this case, a temperature control element 34 is arranged on the top side 18 of the microstructure 12. The temperature control element 34 may be designed as a heating device or as a thermally conductive layer. The temperature control element 34 may be thermally coupled to the temperature control element 34 by a thermally conductive element 36. The thermally conductive element 36 extends from the top side 18 to the underside 16 in a second region R2 of the microstructure 12, wherein in this case the second region R2 is in the form of an outer rim of the microstructure 12. The thermally conductive element 36 is coupled to the connection element 32. Here, the connection element 32 is embodied as an electrical contact. The temperature control element 34 may be supplied with energy for heating and/or for cooling the microstructure 12 by the electrical contact, via the thermally conductive element 36.

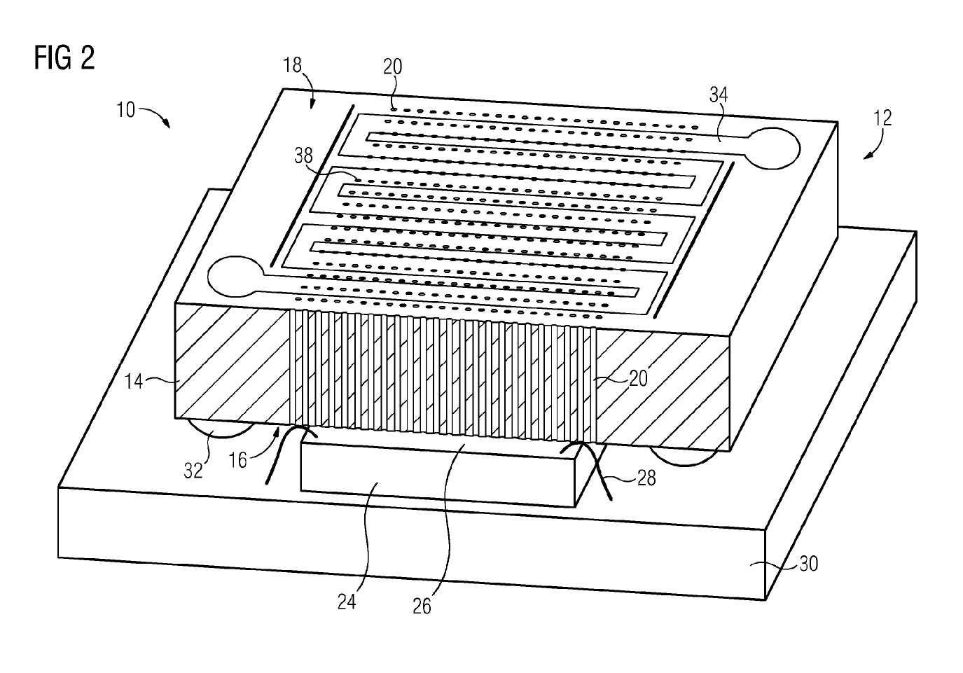

FIG. 2 depicts the apparatus 10 from FIG. 1 in a perspective view. This shows that the temperature control element 34 has through-openings 38. These are coincident with the openings of the micro-channels 20 on the top side 18 of the microstructure 12. Thus, on the top side 18 of the microstructure 12, the openings are not covered and/or closed by the temperature control element 34. It is thus possible for each one of the micro-channels 20 to be traversed by the gas and used for adsorption and/or desorption of the at least one gas component. The through-openings 38 and the openings of the micro-channels 20 may have a round, oval, rectangular or square cross section.

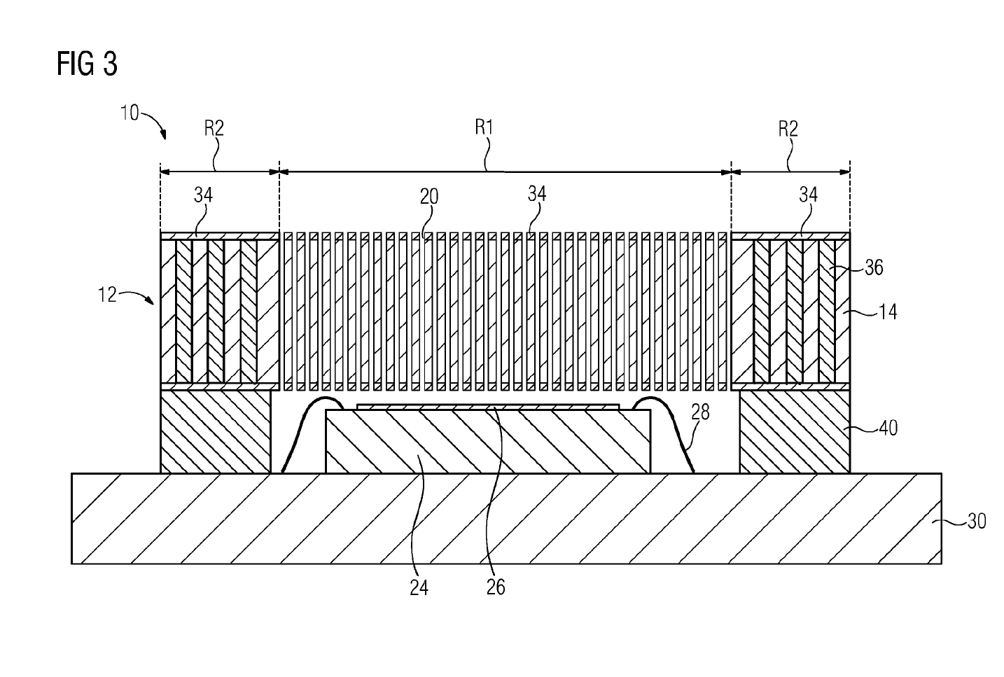

FIG. 3 depicts another embodiment of the apparatus 10. The gas sensor 24 is attached to the support element 30. In this case, the microstructure 12 is arranged above the gas sensor 24 in the vertical direction. In addition, the microstructure 12 is connected to the support element 30 via a device 40 for the provision of thermal energy. Here, the microstructure 12 has, in the second region R2, multiple thermally conductive elements 36 extending from the underside 16 to the top side 18 of the microstructure 12. The temperature control element 34 is in this case designed as a thermally conductive layer. The temperature control element 34 is thermally coupled to the device 40 for the provision of thermal energy by the thermally conductive elements 36. The device 40 for the provision of thermal energy allows the temperature control element 34 to be supplied, via the thermally conductive elements 36, with thermal energy for heating and/or cooling the microstructure 12. The energy for heating may also be supplied by electromagnetic radiation. This may be heat radiation (e.g., infrared), visible light, microwave radiation, or inductive heating using alternating current. The device 40 may be designed as a Peltier heating and cooling system (in an exemplary embodiment not illustrated in its own right, which otherwise corresponds to the illustrated exemplary embodiment, the energy for heating may also be supplied by electromagnetic radiation: this electromagnetic radiation may be heat radiation (e.g., infrared), visible light, microwave radiation, or inductive heating using alternating current).

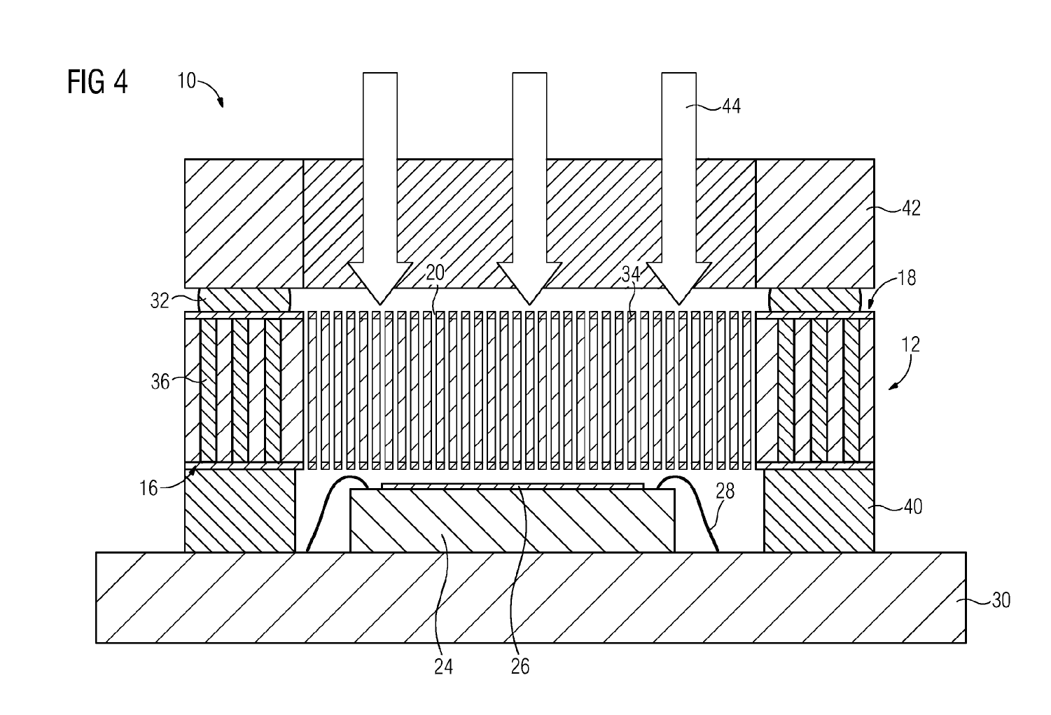

FIG. 4 depicts another embodiment of the apparatus 10 in operation. The apparatus 10 includes the microstructure 12, the gas sensor 24, and a micro-pump 42. In this example, the gas sensor 24, the microstructure 12, and the micro-pump 42 are arranged one above the other in the vertical direction. In this case, the microstructure 12 is connected to the support element 30 via the device 40 for the provision of thermal energy. The sensor surface 26 of the gas sensor 24, which is arranged on the support element 30, is oriented toward the underside 16 of the microstructure 12. The micro-pump 42 is connected to the microstructure 12 via a connection element 32, such that the top side 18 of the microstructure 12 is oriented toward the micro-pump 42. The micro-pump 42 is designed to supply a gas, the flow direction of which is illustrated here by arrows 44, to the microstructure 12, in particular, to the micro-channels 20. The gas, which has at least one gas component that is to be measured, enters the micro-channels 20 via the openings of the micro-channels on the top side 18 of the microstructure 12, flows through the micro-channels 20 and exits the micro-channels 20 via the openings of the micro-channels 20 on the underside 16 of the microstructure 12.

As the gas flows through the micro-channels 20, the gas components contained in the gas, in particular molecules of the gas component, are adsorbed by the surface 22 of the micro-channels 20. The device 40 for the provision of thermal energy allows the temperature control element 34 for increasing the adsorption rate to be supplied with energy for cooling the microstructure 12. This raises the number of molecules adsorbed onto the surface 22. The gas may flow through the microstructure 12, for example, in a predetermined time. During this time, a certain number of molecules, that is to say a certain concentration of the at least one gas component, is adsorbed onto the surface 22 of the micro-channels 20.

For desorption, (e.g., in order to release the molecules located on the surface 22 of the micro-channels 20 of the at least one gas component), the microstructure 12 may be heated by the device 40 for the provision of thermal energy. In that context, the heating energy may be supplied to the temperature control element 34 by the device 40 via the thermally conductive elements 36. Here, the temperature control element 34 is embodied as a thermally conductive layer arranged on the semiconductor substrate 14, for example, silicon. By virtue of the high thermal conductivity of silicon, the heat also spreads within the semiconductor substrate 14, thus heating the semiconductor substrate 14. The heating process may be carried out within a short time, e.g., between 10 and 100 milliseconds. This rapid heating allows the stored gas, that is to say the molecules of the at least one gas component that adhere to the surface 22, to be suddenly released.

The gas components may then land on the sensor surface 26 of the gas sensor 24 that is arranged suitably close. The gas sensor 24 is designed to measure the concentration of the desorbed gas component.

Thus, the exemplary embodiment indicates more sensitive gas detection using a preconcentrator.

Although the disclosure is illustrated more closely and described in detail by way of the exemplary embodiments, the disclosure is not restricted to the disclosed examples and other variations may be derived therefrom by a person skilled in the art without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A microstructure for adsorbing, desorbing, or adsorbing and desorbing at least one gas component of a gas supplied to the microstructure, the microstructure comprising:
a semiconductor substrate with an underside and a top side;
a plurality of micro-channels, wherein each micro-channel extends from the underside to the top side of the semiconductor substrate; and
a surface of the respective micro-channels configured to absorb, desorb, or absorb and desorb the at least one gas component when the gas flows through the respective micro-channels.

2. The microstructure of claim 1, wherein the surface of the respective micro-channels is formed by a surface structure of the respective micro-channels on an internal wall thereof.

3. The microstructure of claim 1, wherein the surface of the respective micro-channels is formed by a coating that is applied to an internal wall of the respective micro-channels.

4. The microstructure of claim 1, further comprising:
a temperature control element configured to control a temperature of the semiconductor substrate.

5. The microstructure of claim 4, wherein the temperature control element is arranged on the top side of the semiconductor substrate.

6. The microstructure of claim 4, wherein the temperature control element has a plurality of through-openings corresponding to the micro-channels, and
wherein the through-openings are arranged in line with the respective micro-channels.

7. The microstructure of claim 1, further comprising:
at least one thermally conductive element extending from the top side to the underside of the semiconductor substrate.

8. The microstructure of claim 7, wherein the micro-channels are arranged in a first region of the semiconductor substrate and the at least one thermally conductive element is arranged in a second region of the semiconductor substrate,
wherein the second region is a different region from the first region.

9. The microstructure of claim 7, wherein the at least one thermally conductive element is thermally coupled to a temperature control element of the microstructure,
wherein the temperature control element is configured to control a temperature of the semiconductor substrate.

10. The microstructure of claim 1, wherein each micro-channel of the plurality of micro-channels has a length of greater than 100 micrometers, a diameter of less than 20 micrometers, or both a length of greater than 100 micrometers and diameter of less than 20 micrometers.

11. A method for producing a microstructure comprising:
providing a semiconductor substrate having an underside and a top side; and
introducing a plurality of micro-channels into the semiconductor substrate by an electrochemical etching method,
wherein each micro-channel extends from the underside to the top side of the semiconductor substrate, and
wherein a surface of the respective micro-channels configured to absorb, desorb, or absorb and desorb the at least one gas component when the gas flows through the respective micro-channels.

12. An apparatus configured to detect at least one gas component, the apparatus comprising:
a microstructure having:
a semiconductor substrate with an underside and a top side;
a plurality of micro-channels, wherein each micro-channel extends from the underside to the top side of the semiconductor substrate; and
a surface of the respective micro-channels configured to absorb, desorb, or absorb and desorb the at least one gas component when gas flows through the respective micro-channels; and
a gas sensor having a sensor surface configured to measure a concentration of the at least one gas component,
wherein the sensor surface of the gas sensor is oriented toward the underside of the microstructure.

13. The apparatus of claim 12, wherein the apparatus further comprises:
a micro-pump arranged relative to the microstructure such that the micro-pump is oriented toward the top side of the microstructure so as to establish a flow of the gas through the micro-channels from the top side to the underside of the microstructure.

14. The apparatus of claim 12, wherein the apparatus further comprises:
a device configured to provide thermal energy,
wherein the device is thermally coupled to at least one thermally conductive element.

15. A method for operating an apparatus comprising:
providing an apparatus comprising: (1) a microstructure having a semiconductor substrate and a plurality of micro-channels, and (2) a gas sensor having a sensor surface,
introducing a gas into the micro-channels of the microstructure for adsorption of at least one gas component contained in the gas on a surface of the micro-channels; and
heating the microstructure for desorption of the at least one gas component and for supplying the at least one desorbed gas component to the gas sensor for measuring the concentration of the at least one gas component in the supplied gas.
